(19) United States
(12) Patent Application Publication
(10) Pub. No.: US 2014/0235764 A1
(43) Pub. Date: Aug. 21, 2014

(54) ENGINE MOUNT RUBBER COMPOSITIONS FOR AGING PREVENTION

(71) Applicants: Kia Motors Corporation, Seoul (KR); Hyundai Motor Company, Seoul (KR)

(72) Inventors: Jong-Min Park, Incheon (KR); Kyung-Mo Yang, Suwon, Gyeonggi-do (KR)

(21) Appl. No.: 13/923,938

(22) Filed: Jun. 21, 2013

(30) Foreign Application Priority Data
Feb. 21, 2013 (KR) 10-2013-0018579

(51) Int. Cl. F16F 1/36

(52) U.S. Cl. CPC F16F 1/3605
USPC 524/93

(57) ABSTRACT

Disclosed is an engine mount rubber composition for aging prevention, and more specifically engine mount rubber composition for aging prevention comprising an anti-aging agent, which consists of: a material participating in chemical bonding in the rubber and inhibiting flowing out of chemical additives such as 2-mercaptobenzimidazole; a material forming a dispersible aging preventing layer on the rubber surface and inhibiting cohesion of the flowed out chemical additives such as N-isopropyl-N′-phenyl-paraphenylenediamine; and a micro wax. The engine mount rubber composition of the present invention has an effect of prolonging life of the engine mount by inhibiting flowing out and cohesion of chemical additives on the rubber surface.

### CROSS-REFERENCE TO RELATED APPLICATION

This application claims priority under 35 U.S.C. §119 to Korean Patent Application No. 10-2013-0018579, filed on Feb. 21, 2013, in the Korean Intellectual Property Office, the disclosure of which is incorporated herein by reference in its entirety.

### BACKGROUND

(a) Technical Field

The present invention relates to an engine mount rubber composition for aging prevention, and more specifically to an engine mount rubber composition for aging prevention, which comprises an anti-aging agent consisting of a mixture of 2-mercaptobenzimidazole (MB), N-isopropyl-N′-phenyl-paraphenylenediamine (IPPD) and a micro wax (microcrystalline wax). The composition prolongs the life of the engine mount by inhibiting out-flow and cohesion of chemical additives on the rubber surface.

(b) Background Art

Vibration and noise are generated by the engines of vehicles, such as automobiles and airplanes, due to various factors. In general, upward and downward movement of a piston and a connecting rod inside the engine, alternating motion of a cylinder, and the like cause vibration and noise. Accordingly, in order to prevent and block the vibration and noise of the engine, an engine mount containing an anti-vibration rubber is disposed between the engine and an automobile frame.

However, when a solid type rubber material is applied to the engine mount, there is a defect in that vibration in the high-frequency domain is not adequately inhibited. In an attempt to overcome the defect, a hydro engine mount, which insulates vibration through a flow system by containing fluid having low viscosity in the engine mount, was developed.

However, aging of the anti-vibration rubber contained in the engine mount is accelerated due to heat generation during high performance of an automobile, an increase of engine room temperature by minimizing the engine room, and an increase of ozone concentration. As a result, the anti-vibration performance is deteriorated and the life of the anti-vibration rubber is shortened.

In an attempt to overcome the problems, many chemical additives have been used for inhibiting aging of the anti-vibration rubber. However, the chemical additives flow out of the rubber and agglutinate to thereby form a floating matter. This floating matter can enter a flowing system inside the hydro engine mount, thereby obstructing the flow of liquid. As a result, its anti-vibration function of the hydro engine mount is lost.

Korean Patent No. 10-0590976 describes an engine mount rubber composition, which has heat resistance and can prevent aging of rubber by comprising carbon black FEF and MT. However, this composition has limited in its ability to prevent aging.

The description provided above as a related art of the present invention is just for helping understanding the background of the present invention and should not be construed as being included in the related art known by those skilled in the art.

### SUMMARY OF THE DISCLOSURE

The present invention provides an engine mount rubber composition for aging prevention comprising an anti-aging agent, which consists of: a material that participates in chemical bonding in the rubber and that inhibits flowing out of chemical additives such as 2-mercaptobenzimidazole; a material that forms a dispersible aging preventing layer on the rubber surface and that inhibits cohesion of flowed out chemical additives, such as N-isopropyl-N′-phenyl-paraphenylenediamine; and a micro wax. Such an engine mount rubber composition prolongs the life of the engine mount by inhibiting flowing out and cohesion of chemical additives on the rubber surface.

According to one aspect, the present invention provides an engine mount rubber composition comprising a natural rubber, the engine mount rubber composition providing aging prevention and comprising an anti-aging agent consisting of a mixture of 2-mercaptobenzimidazole (MB), N-isopropyl-N′-phenyl-paraphenylenediamine (IPPD) and a micro wax (microcrystalline wax). According to preferred embodiments, the amount of the 2-mercaptobenzimidazole is about 1˜5 parts by weight, the amount of the N-isopropyl-N′-phenyl-paraphenylenediamine is about 1˜5 parts by weight and the amount of the micro wax is about 1˜5 parts by weight based on 100 parts by weight of the natural rubber.

According to preferred embodiments, the engine mount rubber composition further comprises: sulfur at about 0.2˜0.7 part by weight, a heat resistant cross-linking agent at about 0.9˜2.5 parts by weight, a cross-linking accelerating agent at about 1.5˜3 parts by weight, an activating agent at about 8˜12 parts by weight and a filler at about 10˜50 parts by weight.

According to preferred embodiments, the heat resistant cross-linking agent consists of a mixture of hexamethylene-1,6-bis(thiosulfate) (HTS), 1,3-bis(citraconimidomethyl)benzene (P900) and N,N-m-phenylenedimaleimide (PMP).

According to preferred embodiments, the cross-linking accelerating agent consists of a mixture of N-cyclohexyl-2-benzothiazole sulfenamide (CZ) and tetramethylthiuramdisulfide (TT).

Preferably, the sulfur and the heat resistant cross-linking agent constitute the cross-linking agent, and a weight ratio of the cross-linking accelerating agent and the cross-linking agent is preferably about 1:0.1˜1.

Further, it is preferred that the activating agent consists of a mixture of stearic acid and zinc oxide (ZnO).

According to preferred embodiments, the filler is formed of carbon black FEF (Fast Extrusion Furnace black).

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a chemical formula of 2-mercaptobenzimidazol;

FIG. 2 is a chemical formula of N-isopropyl-N′-phenyl-paraphenylenediamine; and

FIG. 3 is a chemical formula of a micro wax.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terms and the words used in the specification and claims should not be construed with common or dictionary meanings, but construed as meanings and conception coinciding the spirit of the invention based on a principle that the inventors can appropriately define the concept of the terms to explain the invention in the optimum method.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” i s understood as within a range of normal tolerance in the art, for example within 2 standard d eviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present invention will be described in detail.

In one aspect, the present invention relates to an engine mount rubber composition for aging prevention.

According to a preferred embodiment of the present invention, the engine mount rubber composition comprises a natural rubber, sulfur, a heat resistant cross-linking agent, a cross-linking accelerating agent, an activating agent, an anti-aging agent and a filler. Preferably, the composition contains about 0.2˜0.7 part by weight sulfur, about 0.9˜2.5 parts by weight heat resistant cross-linking agent, about 1.5˜3 parts by weight cross-linking accelerating agent, about 8˜12 parts by weight activating agent, about 1˜15 parts by weight anti-aging agent, and about 10˜50 parts by weight filler, based on 100 parts by weight of the natural rubber.

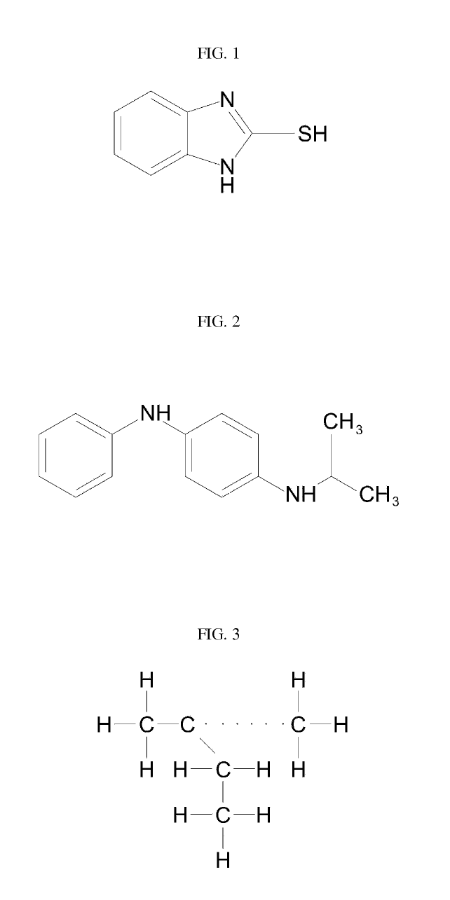

The essential component of the present invention is the anti-aging agent. Preferably, the anti-aging agent is (1) a material that participates in chemical bonding in the rubber and inhibits the flowing out of chemical additives, such as 2-mercaptobenzimidazole, (2) a material that forms a dispersible aging preventing layer on the rubber surface and inhibits cohesion of flowed out chemical additives such as N-isopropyl-N′-phenyl-paraphenylenediamine, and (3) a micro wax. FIG. 1 shows a chemical formula of the 2-mercaptobenzimidazol, FIG. 2 shows a chemical formula of the N-isopropyl-N′-phenyl-paraphenylenediamine, and FIG. 3 show a chemical formula of a micro wax.

Hereinafter, components and content of the present invention will be described in detail.

1. Components (1) Natural Rubber

It is preferred that the present invention contains a natural rubber, and generally is one used for manufacturing an anti-vibration rubber for an automobile. The natural rubber is a fundamental material of the present invention, and it has advantages in that its physical properties, such as strength, heat resistance and durability, can be easily improved when vulcanizing thereof and when a balance of anti-vibration performance and the physical properties is excellent.

(2) Sulfur and Heat Resistant Cross-Linking Agent

The cross-linking agent contains sulfur, a heat resistant cross-linking agent and the like. In the cross-linking reaction by the sulfur, vulcanization of the rubber is a cross-linking reaction, wherein the sulfur plays a role of a cross-link connecting polymers between chain-type polymers. The cross-linking by the sulfur can provide the rubber with mechanical strength properties, such as strength and elasticity and chemical stability. Further, by containing the heat-stable heat resistant cross-linking agent together with the sulfur, heat resistance of the rubber can be additionally improved.

Herein, the heat resistant cross-linking agent may be any such agents known in the art. Preferably, the heat resistant cross-linking agent contains at least one selected from the group consisting of N,N-m-phenylenedimaleimide (PMP), 1,3-bis(citraconimidomethyl)benzene (P900) and hexamethylene-1,6-bis(thiosulfate) (HTS). According to a particularly preferred embodiment, the heat resistant cross-linking agent contains a mixture of PMP, P900 and HTS.

According to embodiments of the present invention, the PMP improves physical properties of the composition while maintaining physical properties thereof, but molding fluidity and anti-vibration performance of the composition may be deteriorated by hardening. However, molding fluidity and anti-vibration performance of the composition can be improved by further by including P900, the HTS and the like. Namely, the molding fluidity and anti-vibration performance deficiencies caused by the PMP can be offset by using the P900 and the HTS.

Further, it is preferred that the amount of the sulfur is about 0.2˜0.7 part by weight, based on 100 parts by weight of the natural rubber. When the amount of the sulfur is less than about 0.2 part by weight, durability of the rubber may be sharply deteriorated and moldability may be decreased. When the amount exceeds about 0.7 part by weight, desired heat resistance properties may not be satisfied.

Further, it is preferred that the amount of the heat resistant cross-linking agent is about 0.9˜2.5 parts by weight, based on 100 parts by weight of the natural rubber. When the amount of the heat resistant cross-linking agent is less than about 0.9 part by weight, physical properties of the composition at room temperature may be deteriorated, and when it exceeds about 2.5 parts by weight, aging of the rubber may be accelerated.

Further, it is preferred that the amounts of the PMP, P900 and HTS of the heat resistant cross-linking agent are about 0.3˜1.5 parts by weight, about 0.3˜1.5 parts by weight and about 0.3˜1.5 parts by weight, respectively, based on 100 parts by weight of the natural rubber. When the amount of the PMP is less than about 0.3 part by weight, heat resistance of the composition may not be enough, and when it exceeds about 1.5 parts by weight, anti-vibration performance may be deteriorated by rapid increase of hardening of the composition. When the amounts of the P900 and the HTS are less than about 0.3 part by weight, the deterioration of the anti-vibration performance by the molding fluidity and the hardening of the composition are not sufficiently offset.

(3) Cross-Linking Accelerating Agent

The cross-linking accelerating agent has an effect of accelerating the cross-linking reaction of the rubber; improving productivity by shortening processing time by: shortening vulcanization time, decreasing vulcanization temperature and reducing the required amount of the cross-linking agent; improving quality of the composition by decreasing the vulcanization temperature; and reducing production costs by reducing the required amount of the cross-linking agent.

The cross-linking accelerating agent may be any such agents known in the art. According to a preferred embodiment, the cross-linking accelerating agent consists of a mixture of N-cyclohexyl-2-benzothiazole sulfenamide (CZ), tetramethylthiuramdisulfide (TT) and the like.

Further, it is preferred that the amount of the cross-linking accelerating agent is about 1.5˜3 parts by weight, based on 100 parts by weight of the natural rubber. When the amount of the cross-linking accelerating agent is less than about 1 part by weight, productivity may be deteriorated by an increased vulcanization time, and when it exceeds about 3 parts by weight, scorching and partial vulcanization may occur, thereby resulting in poor quality products.

According to preferred embodiments, the sulfur and the heat resistant cross-linking agent constitute the cross-linking agent. It is preferred that the weight ratio of the cross-linking accelerating agent and the cross-linking agent is about 1:0.1˜1 (cross-linking accelerating agent:cross-linking agent). When the weight ratio of the cross-linking agent is less than about 0.1, the physical properties of the rubber may be deteriorated by a shortage of the cross-linking agent, and when it exceeds about 1, productivity may be deteriorated by increased cross-linking time due to a saturated performance of the cross-linking accelerating agent.

(4) Activating Agent

The activating agent plays a role of accelerating the cross-linking accelerating agent, which accelerates the cross-linking reaction. As such, the activating agent plays a role of increasing speed of the cross-linking reaction. The activating agent may be any such agents known in the art, but it is preferred that the agent consist of a mixture of stearic acid, zinc oxide (ZnO) and the like.

According to a preferred embodiment, the amount of the activating agent is about 8˜12 parts by weight, based on 100 parts by weight of the natural rubber. When the amount of the activating agent is less than about 8 parts by weight, productivity may be deteriorated by increased vulcanization time due to a rapid decrease of the cross-linking reaction, and when it exceeds about 12 parts by weight, scorching and partial vulcanization may occur, thereby resulting in poor quality products.

(5) Anti-Aging Agent

The anti-aging agent plays a role of maintaining the anti-vibration performance of the engine mount by minimizing the production of foreign substances caused by cohesion of the chemical additives in the hydro engine mount, and reducing the size of the produced foreign substances.

According to preferred embodiments, the amount of the anti-aging agent is about 1˜15 parts by weight, based on 100 parts by weight of the natural rubber. When the amount of the anti-aging agent is less than about 1 part by weight, it may not be enough to play a role of aging prevention of the rubber, and when it exceeds about 15 parts by weight, the physical properties of the rubber may be deteriorated by an imbalance with other components.

According to preferred embodiments, the anti-aging agent contains a material that participates in chemical bonding in the rubber and inhibits flowing out of the chemical additives contained in the rubber, such as 2-mercaptobenzimidazole 2-mercaptobenzimidazol(2-Mercaptobenzimidazole, MB). In addition, it is preferred that the anti-aging agent contains a material that forms a dispersible aging preventing layer on the rubber surface and inhibits flowing out of the chemical additives contained in the rubber and cohesion of the flowed out chemical additives, such as N-isopropyl-N′-phenyl-paraphenylenediamine (IPPD), a micro wax (microcrystalline wax) and the like.

Herein, it is preferred that the anti-aging agent is at least one selected from the group consisting of 2-mercaptobenzimidazol, N-isopropyl-N′-phenyl-paraphenylenediamine, a micro wax and the like. In particular, it is preferred that the anti-aging agent consists of a mixture of the 2-mercaptobenzimidazol, the N-isopropyl-N′-phenyl-paraphenylenediamine, the micro wax and the like.

Specifically, because the N-isopropyl-N′-phenyl-paraphenylenediamine is lower in molecular weight than the micro wax, it flows out first and forms a dispersible aging preventing layer on the surface of the rubber. Thereafter, the micro wax as a polymer slowly flows out and forms a dispersible aging preventing layer on the surface of the rubber. Accordingly, it is possible to form a continuous aging preventing layer on the rubber surface, thereby inhibiting cohesion of the chemical additives contained in the rubber.

According to preferred embodiments, the amount of the 2-mercaptobenzimidazole is about 1˜5 parts by weight, based on 100 parts by weight of the natural rubber. When the amount of the 2-mercaptobenzimidazole is less than about 1 part by weight, it may not be enough to inhibit the flowing out of the chemical additives contained in the rubber, and when it exceeds about 5 parts by weight, it may affect to the physical properties of the rubber.

According to preferred embodiments, the amount of the N-isopropyl-N′-phenyl-paraphenylenediamine is about 1˜5 parts by weight, based on 100 parts by weight of the natural rubber. When the amount of the N-isopropyl-N′-phenyl-paraphenylenediamine is less than about 1 part by weight, it may be difficult to sufficiently play a role of the anti-aging agent due to shortage of the amount flowed out to the rubber surface. When the amount exceeds about 5 parts by weight, the mechanical properties of the rubber may be remarkably deteriorated.

According to preferred embodiments, the amount of the micro wax is about 1˜5 parts by weight, based on 100 parts by weight of the natural rubber. When the amount of the micro wax is less than about 1 part by weight, it may be difficult to sufficiently play a role of the anti-aging agent due to a shortage of the amount flowed out to the rubber surface. When the amount exceeds about 5 parts by weight, the anti-vibration performance of the rubber may be deteriorated due to swelling of the rubber caused by excessive flowing out of the oily micro wax.

(6) Filler

As a filler, carbon black, which plays a role of improving heat resistance and durability of the composition, may be used. Carbon black is classified into SAF, ISAF, HAF, XCF, FEF, GPF, SRF, FT, MT and the like according to American Standard Test Method (ASTM), and it is preferred that the filler is carbon black FEF (Fast Extrusion Furnace black) having average particle diameter of about 40˜48 nm When the particle diameter is less than about 40 nm, the particle numbers to be added may be increased, and thereby heat increased by the increased friction between the particles may accelerate aging of the rubber, and riding comfort may be deteriorated by an increased dynamic spring constant. When the amount exceeds about 48 nm, riding comfort may be improved by a reduced dynamic spring constant, but mechanical properties (e.g., durability) of the rubber composition may be deteriorated.

It is preferred that the amount of the carbon black is about 10˜50 parts by weight, based 100 parts by weight of the natural rubber. Herein, when the amount of the carbon black is less than about 10 parts by weight, the mechanical properties of the rubber composition may be deteriorate due to low hardness thereof, and when it exceeds about 50 parts by weight, the riding comfort and vibration absorbing ability may be insufficient due to excessively increased hardness of the composition.

3. Uses

It is preferred that the engine mount rubber composition for aging prevention according to the present invention is applied to mounts for an airplane, a ship, a cultivator, a motorcycle and an automobile. More preferably, the composition is applied to a hydro engine mount for an automobile.

4. Manufacturing Method

Hereinafter, in another aspect, the present invention relates to a method for manufacturing an engine mount rubber composition for aging prevention.

An engine mount rubber can be manufactured by using the engine mount rubber composition for aging prevention according to the present invention. The method for manufacturing the engine mount rubber composition for aging prevention is not limited to a certain method, and any conventional techniques can generally be used. However, one general method, which can be commonly used in the technical field to which the invention belongs, will be described hereafter.

First of all, the natural rubber, the carbon black, the activating agent, the anti-aging agent and the like are kneaded by using a banbury mixer to obtain a carbon master batch. The sulfur, the heat resistant cross-linking agent and the cross-linking accelerating agent are added to the carbon master batch, and dispersing and mixing thereof is carried out by using a roll mixer followed by manufacturing the engine mount rubber composition for aging prevention by using a compressor.

Hereinafter, the present invention will be described in further detail with reference to examples. It will be obvious to a person having ordinary skill in the art that these examples are illustrative purposes only and are not to be construed to limit the scope of the present invention.

### EXAMPLES

Samples of engine mount rubber compositions for aging prevention according to the present invention (Examples 1 and 2) and the Comparative Example were manufactured based on the components and contents of the following Table 1, and their physical properties were compared. The results were listed in the following Table 2.

TABLE 1

| | | | | Comparative |
|---|---|---|---|---|
| | | Example 1 | Example 2 | Example 1 |
| | | Part by | Part by | Part by |
| Section | Component | Weight | Weight | Weight |
| Rubber | Natural | 100 | 100 | 100 |
| | Rubber (NR) | | | |
| Cross-Linking | Sulfur | 0.5 | 0.5 | 0.8 |
| Agent | PMP | 0.7 | 0.7 | 0.7 |
| | P900 | 0.7 | 0.7 | 0.7 |
| Cross-Linking | CZ | 0.8 | 0.8 | 0.8 |
| Accelerating | TT | 1.2 | 1.2 | 1.2 |
| Agent | | | | |
| Filler | Carbon | 20 | 20 | 20 |
| | Black N550 | | | |
| Activating | Stearic Acid | 3 | 3 | 3 |
| Agent | ZnO | 8 | 8 | 8 |
| Anti-Aging | 3C | 2 | 2 | 2 |
| Agent | MB | 2 | 2 | — |
| | 6PPD | — | — | 1.5 |
| | Paraffin | — | — | 1.5 |
| | Wax | | | |
| | IPPD | 1.5 | 3 | — |
| | Micro Wax | 1.5 | 3 | — |

Sulfur: MIDAS, SP400
PMP: N,N-m-Phenylenedimaleimide
P900: 1,3-Bis(citraconimidomethyl)benzene, FLEXSYS
CZ: N-Cyclohexylbenzothiazole-2-sulfenamide, Dongyang Chemicals, oricel CZ
TT: Tetramethylthiuramdisulfide, Dongyang Chemicals, oricel TT
carbon black N550: Korea Carbon Black, Corax N550(FEF)
ZnO: Zinc Oxide, Hanil Zinc Oxide, 99.5%
3C: N-Phenyl-N′-isopropyl-p-phenylenediamine, Kumho Monsanto Kumanox 3C
MB: 2-Mercaptobenzimidazole, Miwon Chemicals
IPPD: N-isopropyl-N′-phenyl-paraphenylenediamine

Table 1 is a table comparing the components and contents of Examples 1 and 2, which are in accordance with the present invention, and the Comparative Example.

Referring to Table 1, samples of the engine mount rubber composition for aging prevention were prepared. More specifically, a natural rubber was kneaded by using a banbury mixer for 2 min, and then carbon black was added thereto followed by kneading thereof for 10 min. Then, an activating agent, an anti-aging agent and the like were mixed and kneaded for 2 min to prepared a carbon master batch. Sulfur, a heat resistant cross-linking agent and a cross-linking accelerating agent were added to the carbon master batch, and dispersed and mixed by using a roll mixer followed by pressing thereof by using a compressor at 170° C. and 210kg/cm² to manufacture samples of the engine mount rubber composition for aging prevention.

In the case of Examples 1 and 2 of the Table, which include the N-isopropyl-N′-phenyl-paraphenylenediamine (IPPD) and the micro wax (microcrystalline wax) as an anti-aging agent, an aging preventing layer was formed on the surface of the rubber composition. However, in the case of Comparative Example 1, the N-isopropyl-N′-phenyl-paraphenylenediamine and the micro wax, were not contained in the composition, and therefore an effective aging preventing layer was not formed on the surface of the rubber composition.

The results of testing physical properties of the samples of Examples 1 and 2 and the Comparative Example are listed in the following Table 2.

TABLE 2

| | | | | | | Comparative | Aging |
|---|---|---|---|---|---|---|---|
| Item | | | Unit | Example 1 | Example 2 | Example 1 | Condition |
| Sample | Hardness | | HS | 45 | 44 | 45 | — |
| | Tensile Strength | | kgf/cm² | 237 | 209 | 230 | |
| | Elongation Rate | | % | 580 | 552 | 610 | |
| | Hardness Change After Aging | | HS | +7 | +6 | +6 | 85° C. × 1,000 hrs |
| | Variation After | Tensile Strength | % | −40 | −15 | −27 | |
| | Aging | Elongation Rate | % | −42 | −17 | −14 | |

| | | | | | | |
|---|---|---|---|---|---|---|
| | Compression Permanent | % | 20 | 11 | 18 | 100° C. × 22 hrs |
| | Decrease Rate | | | | | |
| | Foreign Substance Production Number | Number | 50,000 | 30,000 | 200,000 | 125° C. × 1,000 hrs |
| | (Mount Solution Resistance Test) | | | | | |
| Product | Room Temperature Durability | Cycle | 2,060,000 | 2,300,000 | 1,700,000 | — |
| | Heat Resistance Durability | Cycle | 850,000 | 980,000 | 100,000 | 120° C. × 100 hrs |
| | Dynamic Ratio | % | 1.40 | 1.36 | 1.42 | — |
| | Dynamic Spring Characteristic | % | 33 | 22 | 80 | — |
| | Variation | | | | | |

The above Table 2 is a table showing the results of the physical property tests conducted by using the samples made according to the components and contents of the above Table 1. The hardness was measured according to KS M 6784, and the tensile strength and the elongation rate were measured according to KS M 6782.

In the case of the foreign substance production number according to contact of the engine mount solution, the number of the produced foreign substance of Example 1 and Example 2 were sharply reduced as compared with Comparative Example 1. Accordingly, when the present invention was applied to a hydro engine mount, it was demonstrated that the lower number of the produced foreign substance enabled anti-vibration performance of the engine mount to be maintained for a long time. Further, although these effects were achieved, it was found that Examples 1 and 2 according to the present invention had equal hardness, tensile strength, elongation rate, compression permanent decrease rate and the like as compared with Comparative Example 1.

The present invention having the constitution described above, contains 2-mercaptobenzimidazole as an anti-aging agent in the engine mount rubber composition, and thereby has an effect of prolonging the life of the engine mount by inhibiting flowing out of the chemical additives added to the rubber composition.

Further, the present composition contains N-isopropyl-N′-phenyl-paraphenylenediamine, a micro wax (microcrystalline wax) and the like as an anti-aging agent, and thereby has an effect of prolonging the life of the engine mount by inhibiting cohesion of the flowed out chemical additives by forming an dispersible aging preventing layer on the rubber composition surface.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. An engine mount rubber composition for aging prevention, the engine mount rubber composition comprising a natural rubber and further comprising:
an anti-aging agent consisting of a mixture of 2-mercaptobenzimidazole (MB), N-isopropyl-N′-phenyl-paraphenylenediamine (IPPD) and a micro wax (microcrystalline wax).

2. The engine mount rubber composition for aging prevention according to claim 1, which comprises about 1˜5 parts by weight of the 2-mercaptobenzimidazole, about 1˜5 parts by weight of the N-isopropyl-N′-phenyl-paraphenylenediamine and about 1˜5 parts by weight of the micro wax, based on 100 parts by weight of the natural rubber.

3. The engine mount rubber composition for aging prevention according to claim 2, which further comprises: about 0.2˜0.7 part by weight of sulfur, about 0.9˜2.5 parts by weight of a heat resistant cross-linking agent, about 1.5˜3 parts by weight of a cross-linking accelerating agent, about 8˜12 parts by weight of an activating agent and about 10˜50 parts by weight of a filler, based on 100 parts by weight of the natural rubber.

4. The engine mount rubber composition for aging prevention according to claim 3, wherein the heat resistant cross-linking agent consists of a mixture of hexamethylene-1,6-bis(thiosulfate) (HTS), 1,3-bis(citraconimidomethyl)benzene (P900) and N,N-m-phenylenedimaleimide (PMP).

5. The engine mount rubber composition for aging prevention according to claim 3, wherein the cross-linking accelerating agent consists of a mixture of N-cyclohexyl-2-benzothiazole sulfenamide (CZ) and tetramethylthiuramdisulfide (TT).

6. The engine mount rubber composition for aging prevention according to claim 3, wherein the sulfur and the heat resistant cross-linking agent constitutes a cross-linking agent, and a weight ratio of the cross-linking accelerating agent and the cross-linking agent is about 1:0.1˜1.

7. The engine mount rubber composition for aging prevention according to claim 3, wherein the activating agent consists of a mixture of stearic acid and zinc oxide (ZnO).

8. The engine mount rubber composition for aging prevention according to claim 3, wherein the filler is carbon black FEF (Fast Extrusion Furnace black).
